(19) United States
(12) Patent Application Publication
(10) Pub. No.: US 2019/0026970 A1
(43) Pub. Date: Jan. 24, 2019

(54) MONEY MANAGEMENT APPARATUS, MONEY HANDLING SYSTEM, AND MONEY HANDLING METHOD

(71) Applicant: GLORY LTD., Himeji-shi, Hyogo (JP)

(72) Inventors: Kazuhiro DOI, Himeji-shi (JP); Asushi MORISAWA, Himeji-shi (JP)

(73) Assignee: GLORY LTD., Himeji-shi, Hyogo (JP)

(21) Appl. No.: 16/069,641

(22) PCT Filed: Jan. 13, 2017
(86) PCT No.: PCT/JP2017/000976

§ 371 Date: Jul. 12, 2018

(30) Foreign Application Priority Data
Jan. 15, 2016 (JP) 2016-006420

(51) Int. Cl. G07D 11/00; G07D 1/00; G07F 19/00; G07G 1/14

(52) U.S. Cl. CPC G07D 11/0057; G07D 1/00; G07D 11/0021; G07D 9/00; G07G 1/14; G07F 19/203; G07F 19/211

(57) ABSTRACT

At the time of dispensing money for replenishing a cash settlement apparatus, to dispense the money in the form of loose money and/or wrapped money based on user requirement, a money handling system is configured to dispense money for replenishing includes at least one cash settlement apparatus configured to store money for being utilized as change, and a money management apparatus including a communication unit configured to acquire information on money for replenishing the cash settlement apparatus, a loose money handling unit configured to dispense loose money for replenishing the cash settlement apparatus, and a wrapped money handling unit configured to dispense wrapped money for replenishing the cash settlement apparatus.

### TECHNICAL FIELD

The present invention relates to a money management apparatus, a money handling system, and a money handling method capable of dispensing money to be used in a store in the form of loose money and/or wrapped money.

### BACKGROUND ART

Conventionally, money handling systems used to replenish a money handling apparatus in stores with money are being used. For example, Patent Document 1 discloses a system that includes a coin roll handling apparatus used to replenish a Point-of-sale (POS) register with change coins to be used as change in the POS register, and an automatic teller machine (ATM) used to replenish the POS register with change banknotes to be used as change in the POS register.

### CITATION LIST

### Patent Document

[Patent Document 1] Japanese Patent No. 4053318

### SUMMARY OF INVENTION

### Technical Problem

However, in the conventional technology explained above, there are situations in which it is not possible to cater to the store's requests concerning money for replenishment. For example, even when there is a requirement of loose coins in the store, coin rolls each obtained by wrapping a predetermined number of coins are dispensed from the apparatus. In such situations, it is not possible to obtain the required number of coins in the required form in the store.

The present invention is made to address the problems in the conventional technology. One object of the present invention is to provide a money management apparatus, a money handling system, and a money handling method capable of dispensing money in the form of loose money and/or wrapped money based on the requirement.

### Means for Solving Problems

To solve the above problems and to achieve the above object, a money handling apparatus according to one aspect of the present invention includes at least one cash settlement apparatus configured to store money for being utilized as change; and a money management apparatus that includes a communication unit configured to acquire information on money for replenishing the cash settlement apparatus; a loose money handling unit configured to dispense loose money for replenishing the cash settlement apparatus; and a wrapped money handling unit configured to dispense wrapped money for replenishing the cash settlement apparatus.

In the present invention, the wrapped money that the wrapped money handling unit dispenses includes at least one coin roll in which a predetermined number of coins are wrapped.

In the present invention, the wrapped money that the wrapped money handling unit dispenses includes at least one banknote bundle in which a predetermined number of banknotes are bundled.

In the present invention, the loose money handling unit receives loose money and stores the loose money inside the apparatus, and utilizes the stored loose money for replenishing the cash settlement apparatus.

In the present invention, the money management apparatus determines, based on information on a money storage quantity of the cash settlement apparatus, a quantity of money to be dispensed for replenishing the cash settlement apparatus.

In the present invention, the money management apparatus determines, based on a quantity of money set to be stored in the cash settlement apparatus and a quantity of money being stored in the cash settlement apparatus, the quantity of money to be dispensed for replenishing the cash settlement apparatus.

In the present invention, the money management apparatus receives information input to identify the cash settlement apparatus, identifies the cash settlement apparatus to be replenished among a plurality of cash settlement apparatuses based on the received information, and determines the quantity of money to be dispensed for replenishing an identified cash settlement apparatus.

In the present invention, the money management apparatus determines the quantity of money to be dispensed for replenishing the cash settlement apparatus such that a determined quantity of money does not exceed a shortfall quantity of money derived by subtracting the quantity of money being stored in the cash settlement apparatus from the quantity of money set to be stored in the cash settlement apparatus.

In the present invention, the money management apparatus determines a breakdown of the loose money to be dispensed from the loose money handling unit and the wrapped money to be dispensed from the wrapped money handling unit such that total quantity of the loose money and the wrapped money is the same as the determined quantity of money to be dispensed for replenishing the cash settlement apparatus.

In the present invention, the money management apparatus determines a maximum quantity of wrapped money such that the quantity of money included in the maximum quantity of wrapped money does not exceed the determined quantity of money to be dispensed for replenishing the cash settlement apparatus, and dispenses the determined maximum quantity of wrapped money.

In the present invention, when the quantity of money included in the determined maximum quantity of wrapped money is less than the determined quantity of money to be dispensed for replenishing the cash settlement apparatus, the money management apparatus dispenses a shortfall quantity of money in a form of loose money.

In the present invention, when the quantity of money included in the determined maximum quantity of wrapped money is less than the determined quantity of money to be dispensed for replenishing the cash settlement apparatus, the money management apparatus dispenses spare wrapped money.

In the present invention, the money management apparatus has setting information set for each cash settlement apparatus, the setting information indicating whether the loose money or the wrapped money is prioritized, and determines, based on the setting information, whether the loose money or the wrapped money is prioritized to dispense the determined quantity of money for replenishing the cash settlement apparatus.

In the present invention, the money management apparatus further includes an operation unit to specify a breakdown of the loose money and the wrapped money to be dispensed for replenishing the cash settlement apparatus.

In the present invention, the money management apparatus compares the determined quantity of money to be dispensed for replenishing the cash settlement apparatus and a total quantity of money derived by summing a quantity of the loose money and a quantity of the wrapped money specified via the operation unit, and performs a predetermined processing.

A money management apparatus according to another aspect of the present invention includes a communication unit configured to acquire information on money to be replenished a cash settlement apparatus that stores money for being utilized as change; a loose money handling unit configured to dispense loose money for replenishing the cash settlement apparatus; and a wrapped money handling unit configured to dispense wrapped money for replenishing the cash settlement apparatus.

A money handling method according to still another aspect of the present invention is a money handling method for dispensing money for replenishing a cash settlement apparatus in a money handling system. The money handling method includes acquiring information on money to be replenished into the cash settlement apparatus; dispensing loose money for replenishing the cash settlement apparatus; and dispensing wrapped money for replenishing the cash settlement apparatus.

### Advantageous Effects of Invention

According to the present invention, by using a money handling system that includes a loose money handling unit configured to dispense loose money and a wrapped money handling unit configured to dispense wrapped money, it is possible to dispense the loose money and the wrapped money. For example, at the time of dispensing coins for replenishing a cash settlement apparatus, when the coin rolls are preferred to carry easily, the coin rolls can be dispensed. For another example, there is a case where it is necessary to remove the wrapping being covering coins in the coin roll in order to replenish a cash settlement apparatus with loose coins. In such a case, the loose coins can be dispensed for replenishing the cash settlement apparatus. Because money can be dispensed in the form of loose money or wrapped money based on the requirement, it is possible to cater to a variety of requirements of the store.

### BRIEF DESCRIPTION OF DRAWINGS

FIG. 1 is a block diagram showing a configuration example of a money handling system according to the present embodiment.

FIG. 2 is a block diagram showing a schematic configuration of a money management apparatus.

FIG. 3 is a schematic diagram showing an overall internal configuration of a loose banknote handling unit.

FIG. 4 is a schematic diagram showing an overall internal configuration of a banknote bundle handling unit.

FIG. 5 is a schematic diagram showing an overall internal configuration of a loose coin handling unit.

FIG. 6 is a schematic diagram showing an overall internal configuration of a coin roll handling unit.

FIG. 7 is a view of an exemplary screen showing coin inventory-amount information.

FIG. 8 is a view of an exemplary screen displayed when an automatic dispensing process is executed.

FIG. 9 is a view of an exemplary screen displayed when the automatic dispensing process in which exceeding of the number of change fund coins is allowed and only coin roll are discharged is executed.

FIG. 10 is a view of an exemplary screen displayed when a manual dispensing process is executed.

### DESCRIPTION OF EMBODIMENTS

Exemplary embodiments of a money management apparatus, a money handling system, and a money handling method according to the present invention are explained below with reference to the accompanying drawings. The money handling system according to the present embodiment is used in a store that provides products and services.

An outline of the money handling system according to the present embodiment is explained below. In the money handling system, when a shortage of money occurs in a cash settlement apparatus that is used to settle the transactions with a customer in a store, a money management apparatus dispenses money for replenishment. The cash settlement apparatus is replenished with the dispensed money. For example, according to the requirement of the store and the usage mode of the cash settlement apparatus, the money management apparatus automatically determines a breakdown of the loose money and the wrapped money that constitute the money for replenishment. A user can easily perform operations for dispensing the money for replenishment and replenishing the cash settlement apparatus with money. The user can change settings used for automatically determining the breakdown of the loose money and the wrapped money. The user can also manually change the breakdown of the loose money and the wrapped money that is automatically determined based on the settings. As a result, the money management system can flexibly cater to the requirements of the user in the store.

In the present embodiment, a process of storing money received from outside of the apparatus into the apparatus is called as a money depositing process. A process of dispensing the money stored inside the apparatus to the outside of the apparatus is called as a money dispensing process. The term of “money” refers to banknotes and/or coins. A single roll obtained by wrapping a predetermined number of loose coins by a wrapping material is called as a coin roll. A single bundle obtained by binding a predetermined number of loose banknotes by a binding material is called as a banknote bundle. The term of “wrapped money” refers to the coin roll and/or the banknote bundle.

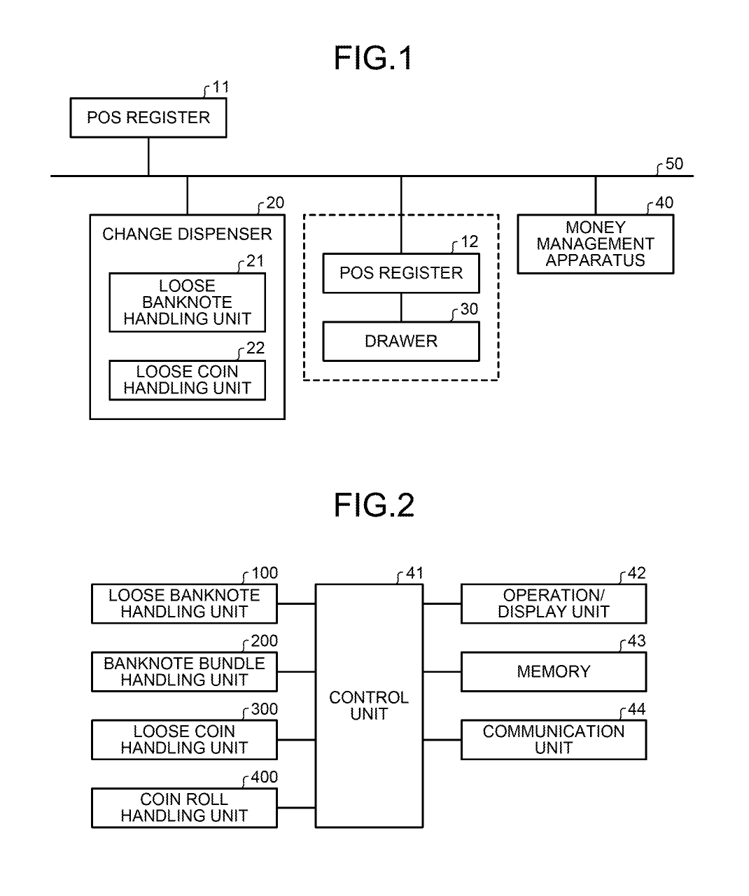

FIG. 1 is a block diagram of a configuration example of the money handling system according to the present embodiment. The money handling system includes a cash settlement apparatus that is used for a cash settlement process at a checkout counter in the store and a money management apparatus 40 that is used for managing money in the store.

The cash settlement apparatus is a money handling apparatus that executes the money depositing process and the money dispensing process at the time of performing the cash settlement process when making a transaction with a customer. An inventory amount of money stored in the cash settlement apparatus is managed. The inventory amount of money in the cash settlement apparatus increases when the money paid by the customer during the transaction is deposited to the apparatus, and decreases when change to be given to the customer is dispensed from the apparatus. For example, a change dispenser 20 functions as the cash settlement apparatus. The change dispenser 20 stores therein the money received from the customer, calculates a change amount based on a price of an item input in a POS register 11 and the money amount received from the customer, and dispenses the change. For another example, there is a case where a cashier stores the money received from the customer in a drawer 30, and takes out the change from the drawer 30 based on the price of the item input in a POS register 12 and the money amount received from the customer. In such a case, as indicated by a broken line in FIG. 1, the drawer 30 provided for depositing and dispensing money and the POS register 12 provided for managing the inventory amount of money in the drawer 30 function as the cash settlement apparatus. The cash settlement apparatus is used at the checkout counter of the store. The money that is used as change is stored in the cash settlement apparatus. In the store, one or more cash settlement apparatuses are installed.

The money management apparatus 40 is used to perform processes such as the money depositing process in which the money collected from the cash settlement apparatus is deposited, the money dispensing process in which the money for replenishing the cash settlement apparatus is dispensed, and a money change process in which the money stored in the cash settlement apparatus is changed. The money management apparatus 40 is installed and used at the back office of the store.

The POS registers 11 and 12, the change dispenser 20, and the money management apparatus 40 are connected to a network 50 such as a LAN. Information on the inventory amount of money stored in the change dispenser 20 and information on the inventory amount of money stored in the drawer 30 is utilized by the money management apparatus 40. The configuration of the money handling system is not limited to that shown in FIG. 1 as long as the money management apparatus 40 can utilize the inventory amount of money stored in each of the cash settlement apparatuses. For example, the money handling system can have a configuration that does not include the POS registers 11 and 12. Alternatively, the money handling system can have a configuration that exchanges information on the inventory amount of money via a means other than the network 50.

A control number is assigned to each of the cash settlement apparatuses such that the money management apparatus 40 can manage the inventory amount of money stored in the plurality of the cash settlement apparatuses. When the plurality of the cash settlement apparatuses are used in combination with the POS registers 11 and 12 as shown in FIG. 1, each of the cash settlement apparatuses is managed by using a cash register number. The cash register numbers are assigned to the POS registers 11 and 12 to distinguish each POS register. These cash register numbers are used as the control numbers of the cash settlement apparatuses. For example, by inputting in the money management apparatus 40 the cash register number of the POS register 11, the user can confirm the inventory amount of money stored in the change dispenser 20 that is used in combination with the POS register 11. Similarly, by inputting in the money management apparatus 40 the cash register number of the POS register 12, the user can confirm the inventory amount of money stored in the drawer 30 that is used in combination with the POS register 12.

The change dispenser 20 includes a loose banknote handling unit 21 and a loose coin handling unit 22. The loose banknote handling unit 21 performs the money depositing process and the money dispensing process of the loose banknotes. The loose coin handling unit 22 performs the money depositing process and the money dispensing process of the loose coins. During the cash settlement process, the loose banknote handling unit 21 and the loose coin handling unit 22 perform the depositing process. The loose banknote handling unit 21 recognizes the denominations and the number of the loose banknotes received from the customer and stores those loose banknotes therein, and the loose coin handling unit 22 recognizes the denominations and the number of the loose coins received from the customer and stores those loose coins therein. Then, the change dispenser 20 acquires from the POS register 11 the item price to be paid by the customer. The change dispenser 20 calculates the change amount based on the money amount to be paid by the customer and the total money amount of the loose banknotes and the loose coins received from the customer. The change dispenser 20 performs, when required, the money dispensing process in which the loose banknote handling unit 21 dispenses change banknotes and the loose coin handling unit 22 dispenses change coins. The change dispenser 20 manages the denominations, and the number of pieces of money of each denomination as the inventory amount of money stored therein. The change dispenser 20 also manages change of the inventory amount due to the money depositing process and the money dispensing process.

The inside of the drawer 30 is partitioned into a plurality of storage spaces such that the banknotes and the coins can be stored in the respective storage spaces by denomination. During the cash settlement process, the cashier inputs in the POS register 12 the item price and the money amount received from the customer, and stores the money received from the customer in the drawer 30. The cashier takes out, when required, money from the drawer 30 and returns to the customer as change. The POS register 12 manages the inventory amount of money changed due to the money depositing process and the money dispensing process. For example, the cashier inputs in the POS register 12 the denominations and the number of pieces of the money paid by the customer. The POS register 12 specifies the denominations and the number of pieces of money to be returned as change from the cashier to the customer. By specifying the denominations and the number of pieces of money to be returned as the change, the POS register 12 can manage the denominations, and the number of pieces of money of each denomination as the inventory amount of the money stored in the drawer 30. Alternatively, for example, a detection mechanism is provided in each of the storage spaces inside the drawer 30 to detect the number of banknotes or coins stored by denomination therein. In this configuration, the POS register 12 automatically calculates the denominations and the number of pieces of money of each denomination, and manages as the inventory amount of the money stored in the drawer 30. Alternatively, concerning the inventory amount of the money stored in the drawer 30, only the total money amount stored in the drawer 30 is managed as the inventory amount, based on the money amount deposited in and dispensed from the drawer 30 at the time of the cash settlement process. In such configuration, for example, the detection mechanism is provided in each storage space inside the drawer 30, and the inventory amount of the money stored in the drawer 30 is calculated automatically by using the detection mechanism.

FIG. 2 is a block diagram showing a schematic configuration of the money management apparatus 40. The money management apparatus 40 includes a loose banknote handling unit 100, a banknote bundle handling unit 200, a loose coin handling unit 300, a coin roll handling unit 400, a control unit 41, an operation/display unit 42, a memory 43, and a communication unit 44.

The operation/display unit 42 is, for example, a touch panel liquid crystal display device. The operation/display unit 42 displays information on the money depositing process and the money dispensing process. The information on settings and instructions is input into the operation/display unit 42 by operating the operation/display unit 42. When a money depositing process or a money dispensing process is instructed by operating the operation/display unit 42, the control unit 41 controls the loose banknote handling unit 100, the banknote bundle handling unit 200, the loose coin handling unit 300, and the coin roll handling unit 400 to perform the instructed process. The control unit 41 controls the functions and operations of each of the units to realize the processes explained in the present embodiment. The memory 43 is a nonvolatile memory device, and is used to store therein computer programs and data that the control unit 41 requires to control various units. The communication unit 44 acquires via the network 50 the information on the inventory amount of the money stored in the change dispenser 20 and the inventory amount of the money stored in the drawer 30.

The loose banknote handling unit 100 and the banknote bundle handling unit 200 are arranged side by side. The loose banknote handling unit 100 and the banknote bundle handling unit 200 are internally connected with each other. A predetermined number of the loose banknotes (for example, 100 loose banknotes) stored in the loose banknote handling unit 100 are transported from the loose banknote handling unit 100 to the banknote bundle handling unit 200 without being discharged to the outside of the apparatuses, and the banknote bundle handling unit 200 bundles those loose banknotes.

The loose coin handling unit 300 and the coin roll handling unit 400 are arranged side by side. The loose coin handling unit 300 and the coin roll handling unit 400 are internally connected with each other. A predetermined number of the loose coins stored in the loose coin handling unit 300 (such as 25 coins or 50 coins) are transported from the loose coin handling unit 300 to the coin roll handling unit 400 without being discharged to the outside of the apparatuses, and the coin roll handling unit 400 wraps those loose coins.

The number of pieces of money included in one wrapped money can be set for each denomination. In the present embodiment, the explanation is given by assuming that one banknote bundle includes 100 loose banknotes and one coin roll includes 50 loose coins.

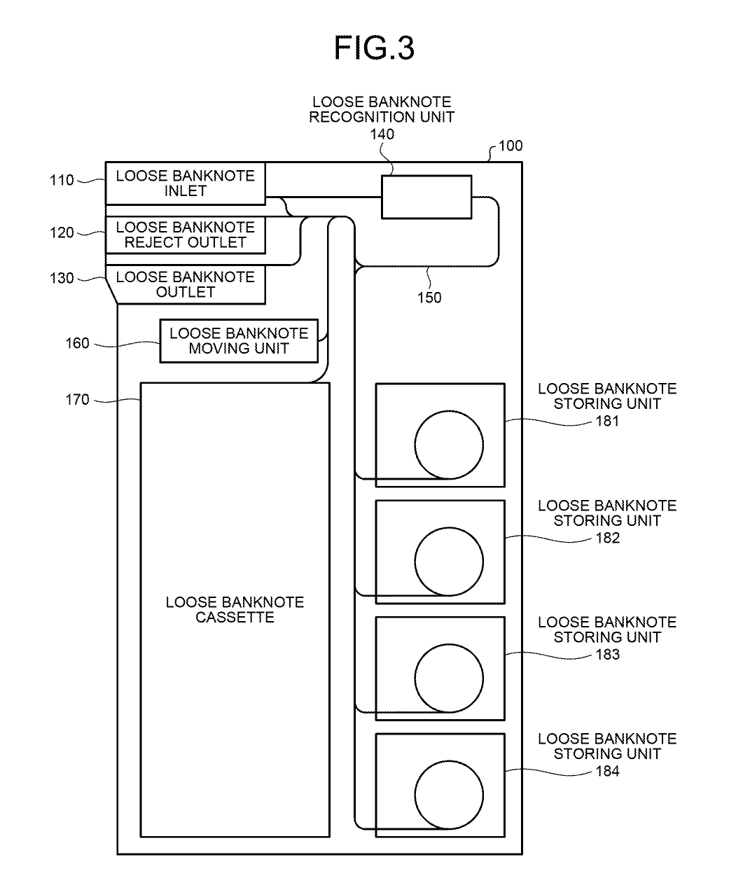

FIG. 3 is a schematic diagram showing an overall internal configuration of the loose banknote handling unit 100. The loose banknote handling unit 100 performs the money depositing process and the money dispensing process of the loose banknotes. At the time of performing the money depositing process, when the loose banknotes to be deposited are inserted into a loose banknote inlet 110, the loose banknotes are fed inside the apparatus one by one and transported by a loose banknote transport unit 150. A loose banknote recognition unit 140 recognizes the denomination, authenticity, fitness, and the like of the loose banknote that is being transported. Depending on the recognition result, the loose banknotes that cannot be deposited are rejected and transported to a loose banknote reject outlet 120 as reject banknotes. On the other hand, the loose banknotes that can be deposited are sorted by denomination and stored in a plurality of loose banknote storing units 181 to 184 by denomination.

At the time of performing the money dispensing process, based on the denominations and the number of loose banknotes that are instructed to be dispensed by operating the operation/display unit 42, the loose banknotes to be dispensed are fed from the corresponding loose banknote storing units 181 to 184. The fed loose banknotes are transported by the loose banknote transport unit 150 and are discharged from a loose banknote outlet 130. Also, when the control unit 41 determines the denominations and the number of loose banknotes to be dispensed, the loose banknotes are dispensed in the same way.

A loose banknote cassette 170 is a cassette-type banknote storing unit that is detachably attached to the loose banknote handling unit 100. For example, when collecting the loose banknotes from the loose banknote storing units 181 to 184, the loose banknotes are fed from the loose banknote storing units 181 to 184 and stored in the loose banknote cassette 170. The user can remove the loose banknote cassette 170 from the loose banknote handling unit 100 and carry the same.

A loose banknote moving unit 160 moves the loose banknotes from the loose banknote handling unit 100 to the banknote bundle handling unit 200. Specifically, when 100 loose banknotes fed from the loose banknote storing units 181 to 184 are stacked in the loose banknote moving unit 160, the loose banknote moving unit 160 moves those 100 loose banknotes in a stacked state to the banknote bundle handling unit 200.

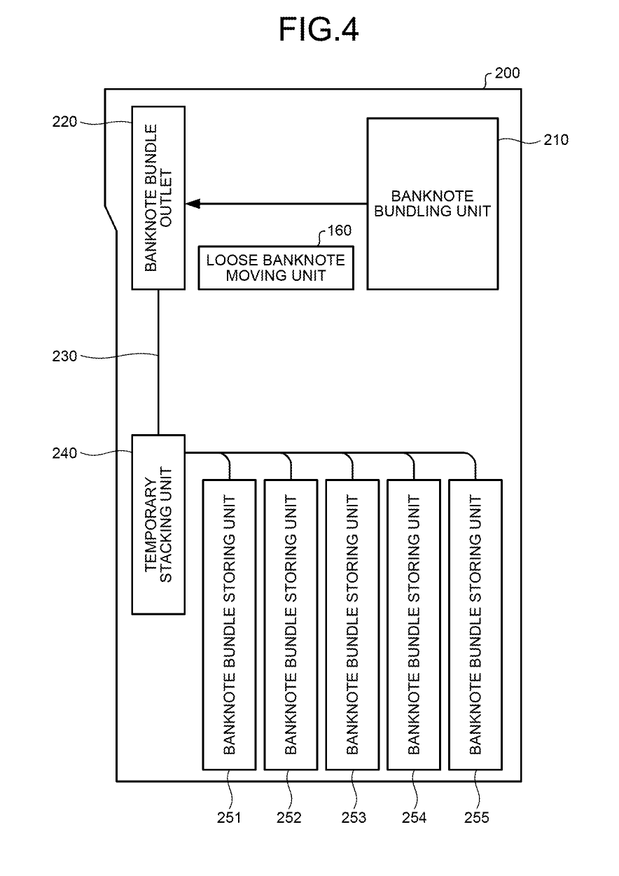

FIG. 4 is a schematic diagram showing an overall internal configuration of the banknote bundle handling unit 200. The 100 loose banknotes in a stacked state moved by the loose banknote moving unit 160 are bundled by a banknote bundling unit 210 to create a banknote bundle. The banknote bundle created by the banknote bundling unit 210 is dispensed from a banknote bundle outlet 220. Alternatively, the banknote bundle created by the banknote bundling unit 210 is transported by a banknote bundle transport unit 230, and stored in any of banknote bundle storing units 251 to 255. The banknote bundles are stored by denomination in those banknote bundle storing units 251 to 255.

When performing the dispensing process of the banknote bundle, based on the denominations and the number of banknote bundles that are instructed to be dispensed by operating the operation/display unit 42, the loose banknotes are moved to the banknote bundle handling unit 200 from the loose banknote handling unit 100 and bundled to create the banknote bundles, and the created banknote bundles are dispensed. Alternatively, based on the denominations and the number of the banknote bundles instructed to be dispensed, the banknote bundles are fed from the banknote bundle storing units 251 to 255 and dispensed. In such a case, the banknote bundles fed from the banknote bundle storing units 251 to 255 are temporarily stacked in a temporary stacking unit 240, and are then discharged from the banknote bundle outlet 220. Also, when the control unit 41 determines the denominations and the number of banknote bundles to be dispensed, the banknote bundles are dispensed in the same way.

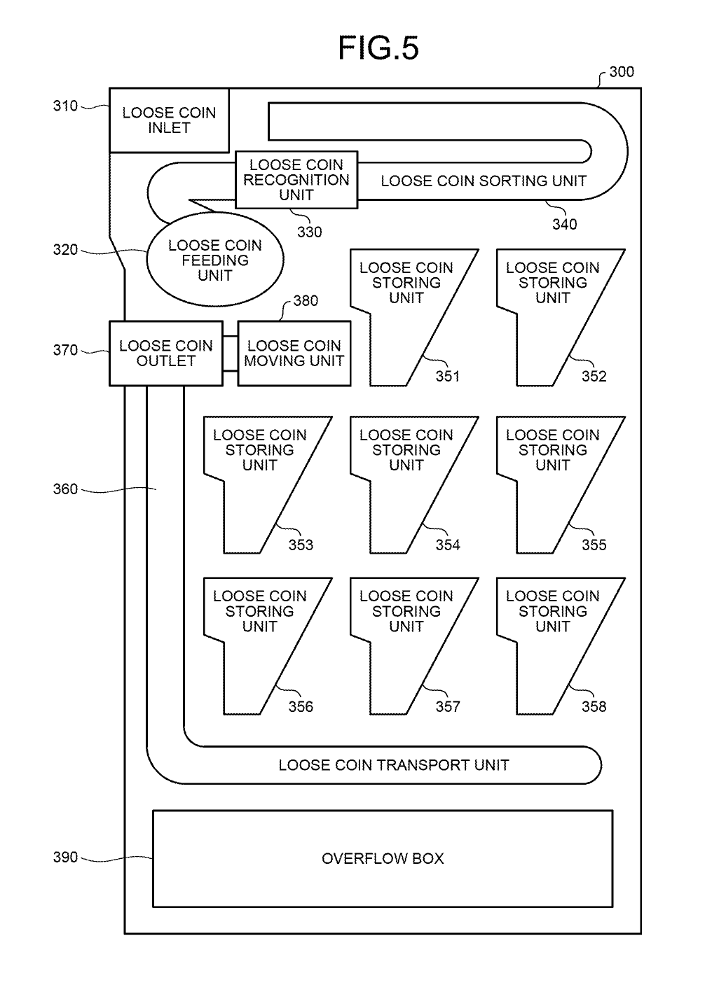

FIG. 5 is a schematic diagram showing an overall internal configuration of the loose coin handling unit 300. The loose coin handling unit 300 performs the money depositing process and the money dispensing process of the loose coins. At the time of performing the money depositing process, when the loose coins to be deposited are inserted into a loose coin inlet 310, all the inserted coins are stored in a loose coin feeding unit 320. The loose coin feeding unit 320 feeds the loose coins one by one. The fed coins are transported by a loose coin sorting unit 340. A loose coin recognition unit 330 recognizes the denomination, authenticity, fitness, and the like of the loose coin that is being transported. A chute is provided to connect the loose coin sorting unit 340 and a loose coin outlet 370. The loose coins recognized by the loose coin recognition unit 330 as the coins that cannot be deposited are rejected to the loose coin outlet 370 via the chute. On the other hand, the loose coins that can be deposited are sorted by denomination and stored in a plurality of loose coin storing units 351 to 358 by denomination. A plurality of the chutes is provided to connect each of the loose coin storing units 351 to 358 and the loose coin sorting unit 340. Depending on the result of the recognition performed by the loose coin recognition unit 330, each loose coin is stored in the corresponding one among the loose coin storing units 351 to 358 via the corresponding chute.

At the time of performing the money dispensing process, based on the denominations and the number of loose coins that are instructed to be dispensed by operating the operation/display unit 42, the loose coins to be dispensed are fed from the corresponding loose coin storing units 351 to 358. The fed loose coins are transported by a loose coin transport unit 360 and dispensed from the loose coin outlet 370. Also, when the control unit 41 determines the denominations and the number of loose coins to be dispensed, the loose coins are dispensed in the same way.

A feeding process in which the loose coin feeding unit 320 feeds the loose coins one by one to the loose coin sorting unit 340 for the depositing process, and other feeding processes in which the loose coin storing units 351 to 358 feed the loose coins one by one to the loose coin transport unit 360 for the money dispensing process are performed, for example, by using a rotary disk that rotates in an inclined state.

An overflow box 390 is a box-shaped coin storing unit that is detachably attached to the loose coin handling unit 300. When the loose coin storing units 351 to 358 are full and cannot accept more coins, the excess loose coins are stored in the overflow box 390. For example, when collecting loose coins from the loose coin storing units 351 to 358, the loose coins are fed from the loose coin storing units 351 to 358 and stored in the overflow box 390. The user can remove the overflow box 390 from the loose coin handling unit 300 and carry the same.

A loose coin moving unit 380 moves the loose coins from the loose coin handling unit 300 to the coin roll handling unit 400. Specifically, when 50 loose coins fed from the loose coin storing units 351 to 358 are transported via the loose coin outlet 370 and stacked in the loose coin moving unit 380, the loose coin moving unit 380 moves those 50 loose coins to the coin roll handling unit 400.

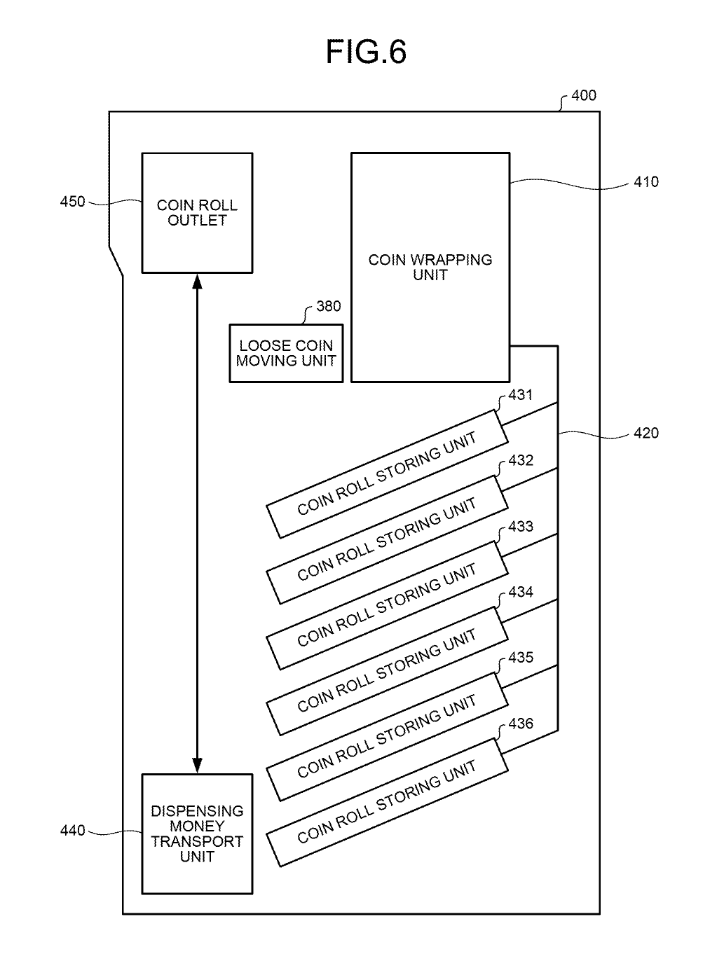

FIG. 6 is a schematic diagram showing an overall internal configuration of the coin roll handling unit 400. The 50 loose coins moved by the loose coin moving unit 380 are wrapped in a coin wrapping unit 410 to create a coin roll. The coin roll created in the coin wrapping unit 410 is transported by a coin roll transport unit 420 and stored in one of coin roll storing units 431 to 436.

The coin rolls are stored in a plurality of the coin roll storing units 431 to 436 based on denominations thereof. The coin roll storing units 431 to 436 are provided such that the front surface side of the apparatus (left side in the drawing) is inclined lower than the back surface side of the apparatus (right side in the drawing). The coin roll created by wrapping 50 loose coins in the form of a rod is arranged such that the axis of the rod is along the apparatus lateral direction (front/back direction of the diagram), and stored in the coin roll storing units 431 to 436 from the back surface side of the apparatus. Inside the inclined coin roll storing units 431 to 436, the stored coin rolls move toward the front surface side of the apparatus. The coin roll stored in the coin roll storing units 431 to 436 can be taken out one by one from the front surface side of the apparatus.

At the time of performing the money dispensing process of the coin rolls, after an operation for instructing the denominations and the number of coin rolls to be dispensed is performed on the operation/display unit 42, a dispensing money transport unit 440 provided at the bottom of the apparatus moves upward while taking out the coin roll from the front surface side of the corresponding coin roll storing units 431 to 436. The dispensing money transport unit 440 dispenses the taken out coin roll from a coin roll outlet 450. Also, when the control unit 41 determines the denominations and the number of coin rolls to be dispensed, the coin rolls are dispensed in the same way.

Upon starting the money management apparatus 40, a main menu screen for selecting and executing the money depositing process, the money dispensing process, the money change process, and the like is displayed on the screen of the operation/display unit 42. For example, after the end of the business hours of the store, the cashiers in charge of each checkout counter collects money from the change dispenser 20 and the drawer 30 that are used as the cash settlement apparatus in the store. The cashier takes the collected money and goes to the back office. The cashier selects the money depositing process from the main menu screen of the money management apparatus 40 installed at the back office, and executes the money depositing process. The cashier who executes the money depositing process operates the operation/display unit 42, and inputs in the money management apparatus 40 information such as the cash register number of the POS registers 11 and 12 and the like (the control number of the cash settlement apparatus), and then deposits the collected money into the loose banknote handling unit 100 and the loose coin handling unit 300.

The money management apparatus 40 is communicably connected to the POS registers 11 and 12 and the change dispenser 20. The money management apparatus 40 manages the inventory amount of the money stored in the change dispenser 20 and the drawer 30. The user inputs in the money management apparatus 40 the cash register number of the POS register 11 and deposits the money collected from the change dispenser 20, or the user inputs the cash register number of the POS register 12 and deposits the money collected from the drawer 30. Accordingly, the money management apparatus 40 can manage the information on the collected money and the inventory amount for each cash settlement apparatus. The collected money quantity is equal to the money quantity reduced from the inventory amount of the change dispenser 20 and the drawer 30. By calculating the deposited quantity of the collected money, the money management apparatus 40 can recognize and manage the inventory amount of the change dispenser 20 and the drawer 30 after the collection.

For example, when money to be used as change becomes insufficient during the business hours of the store and it is necessary to replenish the change dispenser 20 or the drawer 30 with the money, the cashier selects the money dispensing process on a menu screen of the operation/display unit 42, and executes the dispensing process of money for replenishment. At the time of executing the money dispensing process, the cashier can select whether to receive banknotes or coins.

When the banknotes that are to be used as change are required in the cash register, the cashier performs operation to cause the loose banknote handling unit 100 to dispense the loose banknotes. Concerning the coins to be used as change, in some cases, it is preferable to have loose coins dispensed, and in some cases, it is preferable to have coin rolls dispensed. For example, when dispensing a large number of coins, the coin rolls are preferred over the loose coins. For example, when the cash register is installed far from the back office, the coin rolls are preferred because these are easy to carry. For example, when it is required to unwrap the coin rolls at the time of replenishing into the cash settlement apparatus, loose coins are preferable so that the labor required for unwrapping can be saved.

The money management apparatus 40 automatically determines, depending on the number of the coins required for the change dispenser 20 and/or the drawer 30 and/or the usage mode of the change dispenser 20, the breakdown of the loose coins and the coin rolls to be dispensed for replenishment. Alternatively, the user can manually specify the breakdown of the loose coins and the coin rolls. The money dispensing process to dispense the coins to be replenished into the cash settlement apparatus as the change will be explained below.

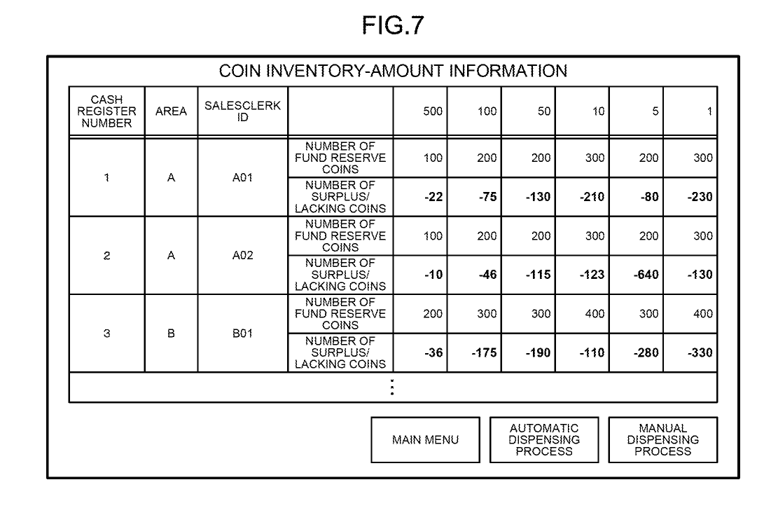

When the money dispensing process of coins starts, information on the inventory amount of the coins stored in the cash settlement apparatus used at each of the checkout counters in the store is displayed on the screen of the operation/display unit 42. FIG. 7 is a view of an exemplary screen showing coin inventory-amount information.

Cash register information and coin information are displayed on the screen on which the coin inventory-amount information is displayed. The cash register information includes information on the cash register installed in the store. The coin information includes information on the coins stored in the cash settlement apparatus used in each of the checkout counters. As the cash register information, the cash register number of each POS register 11 and 12 (the control number of the cash settlement apparatus), an area indicating a selling space and the like in which each POS register 11 and 12 is installed, and a salesclerk ID, which is an identification number for distinguishing cashiers that are in charge of each POS register 11 and 12, are displayed.

As the coin information, information on the denominations and the number of coins that are set as the change fund of each cash register, and information for specifying the denominations and the number of coins currently being stored in the cash settlement apparatus of each checkout counter are displayed. The information on the change fund indicates the denominations and the number of pieces of the money set so as to be stored in each cash settlement apparatus as change before the business of the store starts. The denominations and the number of pieces of money that constitute the change fund are set, for example, for each area or each cash register. In an example shown in FIG. 7 in which the change fund is set for each area, the number of the coins that constitute the change fund is different between an area A and an area B.

The number of fund reserve coins shown in FIG. 7 indicates the number of coins of each denomination to be stored in the cash settlement apparatus of each checkout counter as change fund. The number of surplus/lacking coins shown in FIG. 7 indicates the number of coins which are currently surplus or lacking coins against the number of fund reserve coins. The number of surplus/lacking coins indicated in a negative numerical value shows the number of coins that are currently lacking from the number of coins set as the chance fund (the number of fund reserve coins shown in the figure). The number of surplus/lacking coins indicated in a positive numerical value shows the number of coins that are currently surplus than the number of coins set as the change fund (the number of fund reserve coins shown in the figure). Accordingly, the current number of coins (inventory amount) can be calculated by summing the number of fund reserve coins and the number of surplus/lacking coins. Instead of or in addition to the number of surplus/lacking coins, a setting can be performed so as to display on the screen the number of the coins currently being stored in the cash settlement apparatus.

FIG. 7 shows an example in which the POS register 11 with the cash register number “1” is installed in the area “A”, and the person in charge is a cashier with the salesclerk ID “A01” at the time of displaying this screen to perform the money dispensing process.

At the checkout counter where the POS register 11 shown in FIG. 1 is installed, the change dispenser 20 is used as the cash settlement apparatus. In FIG. 7, the change fund that is set to be stored in the change dispenser 20 before the start of the store business is shown. In FIG. 7, an example is shown in which the change fund of JPY that includes 100 JPY 500-yen coins, 200 JPY 100-yen coins, 200 JPY 50-yen coins, 300 JPY 10-yen coins, 200 JPY 5-yen coins, and 300 JPY 1-yen coins is stored in the change dispenser 20.

When the store opens for business and customer transaction is performed, the money depositing process in which the coins received from the customer are deposited, and the money dispensing process in which the coins are returned to the customer as the change are performed. FIG. 7 shows that, at the time of displaying this screen to perform the money dispensing process, the number of the JPY 500-yen coins stored in the change dispenser 20 has decreased by 22 coins from the initial 100 coins, and the current number of coins is 78 coins as a result of transactions performed with customers. Even for the other denominations, the number of fund reserve coins stored before the start of business and the number of surplus/lacking coins at the time are similarly displayed on the screen.

Information on the change fund stored for each cash register is managed by the money management apparatus 40. Information on the money depositing process and the money dispensing process performed in the change dispenser 20 is transmitted from the change dispenser 20 or the POS register 11 to the money management apparatus 40. Accordingly, the money management apparatus 40 can recognize the number of coins by denomination currently stored in the change dispenser 20, as the inventory amount. For example, for every transaction with customers, information on the money that is deposited and dispensed is transmitted from the change dispenser 20 or the POS register 11 to the money management apparatus 40. Upon receiving the information, the money management apparatus 40 manages the information on the inventory amount of the change dispenser 20. Alternatively, at the start of the money dispensing process by the money management apparatus 40, the money management apparatus 40 acquires from the change dispenser 20 or the POS register 11 the inventory-amount information of the change dispenser 20.

When the cashier touches a main menu button on the screen shown in FIG. 7, the screen returns to the main menu screen. When the cashier touches an automatic dispensing button, an automatic dispensing process begins. When the cashier touches a manual dispensing button, a manual dispensing process begins.

When the automatic dispensing process is selected by touching the automatic dispensing button, a screen that prompts the user to input the cash register number, the area and the salesclerk ID is displayed. When the cashier operates the operation/display unit 42 and inputs information on the cash register number, the area and the salesclerk ID, a processing screen of the automatic dispensing process is displayed. Regarding the settings for identifying the cash settlement apparatus, the information to be input can be changed as long as the cash settlement apparatus can be identified based on input information. For example, the settings can be changed such that input of only the cash register number or the salesclerk ID is prompted.

In the following explanation, it is assumed that the cashier with the salesclerk ID “A01” is in charge of the POS register 11 with the cash register number “1” installed at the checkout counter in the area “A”. The automatic dispensing process, in which the coins are dispensed by the cashier to replenish into the change dispenser 20 used as the cash settlement apparatus at the checkout counter, is explained below.

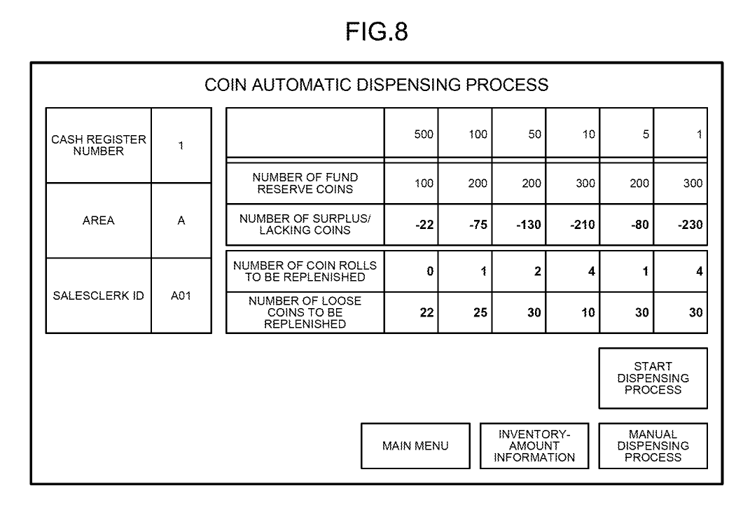

FIG. 8 is a view of an exemplary screen displayed when the automatic dispensing process is executed. On the automatic dispensing process screen, the cash register information, the information on the inventory amount of the coins stored in the change dispenser 20, and information on the coins to be dispensed from the money management apparatus 40 for replenishing the change dispenser 20 are displayed. As the cash register information, the cash register number, the area, and the salesclerk ID are displayed. As the information on the inventory amount of coins, the number of fund reserve coins set as the change fund to be stored in the change dispenser 20 and the number of surplus/lacking coins that indicates the number of coins that are currently surplus/lacking from the number of fund reserve coins are displayed.

The number of coin rolls to be replenished shown in FIG. 8 indicates the number of coin rolls (coin bar) to be dispensed for replenishing. The number of loose coins to be replenished shown in FIG. 8 indicates the number of loose coins to be dispensed for replenishing. The number of coin rolls to be replenished and the number of loose coins to be replenished are information on the breakdown of the coin rolls and the loose coins to be dispensed from the money management apparatus 40 for replenishing. The control unit 41 of the money management apparatus 40 determines such a breakdown based on the number of fund reserve coins and the number of surplus/lacking coins. Alternatively, the control unit 41 calculates the number of lacking coins with respect to the number of fund reserve coins based on the number of fund reserve coins and the inventory amount of coins, and determines the breakdown based on the calculated number of lacking coins.

Specifically, the money management apparatus 40 determines a maximum number of coin rolls such that the number of lacking coins with respect to the number of fund reserve coins are dispensed in the form of as many coin rolls as possible. The determined maximum number of coin rolls is the number of coin rolls to be replenished. The number of coins that cannot be dispensed in the form of the coin roll is the number of loose coins to be replenished. In other words, the money management apparatus 40 uses the coin rolls on priority to reduce the number of lacking coins with respect to the number of fund reserve coins, and determines, as the number of coin rolls to be replenished, the number of coin rolls used for replenishment such that the number of coins being stored after the replenishment does not exceed the number of fund reserve coins.

The money management apparatus 40 determines the number of loose coins such that the number of coins combined with the number of coins to be dispensed in the form of coin rolls becomes the same as the number of lacking coins. The determined number of loose coins is used as the number of loose coins to be replenished. In other words, the money management apparatus 40 determines the number of loose coins to be replenished such that, upon replenishing the change dispenser 20 with the determined number of loose coins and the determined number of coin rolls, the number of coins stored in the change dispenser 20 becomes the same as that of fund reserve coins.

In the example shown in FIG. 8, the number of JPY 500-yen fund reserve coins is 100. The number of lacking coins with respect to that of fund reserve coins is currently 22. When one coin roll in which 50 JPY 500-yen coins are wrapped is dispensed, the number of dispensed coins exceeds 22 coins in lacking. Therefore, the money management apparatus 40 determines that the number of coin rolls to be replenished is zero. Based on this determination, all 22 lacking coins need to be replenished in the form of loose coins. Therefore, the money management apparatus 40 determines that the number of loose coins to be replenished is 22.

The number of JPY 100-yen fund reserve coins is 200. The number of lacking coins is currently 75. The money management apparatus 40 determines the number of coin rolls to be replenished as 1 such that the number of coins included in dispensed coin rolls each wrapping 50 JPY 100-yen coins does not exceed 75 coins in lacking. The money management apparatus 40 determines that the number of loose coins to be replenished is 25 (that is, “75 coins−50 coins×1 coin roll”) such that the total of the number of coins in one coin roll and the number of loose coins to be replenished is equal to the lacking 75 coins. Also, for the JPY 10-yen coin, the JPY 5-yen coin, and the JPY 1-yen coin, the number of coin rolls to be replenished and the number of loose coins to be replenished are determined so as to include as many coin rolls as possible.

The cashier confirms the screen showing the number of coin rolls to be replenished and the number of loose coins to be replenished determined by the money management apparatus 40. When the cashier touches a dispensing start button on the screen, the money management apparatus 40 starts the money dispensing process in which the coin rolls corresponding to the number of coin rolls to be replenished and the loose coins corresponding to the number of loose coins to be replenished are dispensed. Specifically, the coin rolls corresponding to the number of coin rolls to be replenished of each denomination are dispensed from the coin roll outlet 450 of the coin roll handling unit 400. Similarly, loose coins corresponding to the number of loose coins to be replenished of each denomination are dispensed from the loose coin outlet 370 of the loose coin handling unit 300.

The settings of the loose coin dispensing process can be changed as desired. In one setting, all of the loose coins are dispensed in a denomination-mixed state from the loose coin outlet 370. In another setting, the loose coins are dispensed from the loose coin outlet 370 by denomination, one denomination at a time. In the setting in which denomination-mixed loose coins are dispensed, loose coins of various denominations are continuously dispensed from the loose coin outlet 370.

On the other hand, in the setting in which loose coins are dispensed by denomination, one denomination at a time, the process of dispensing loose coins of each denomination is performed sequentially. For example, after 22 JPY 500-yen loose coins are dispensed from the loose coin outlet 370, the cashier takes out those JPY 500-yen coins present in the loose coin outlet 370. Subsequently, when the cashier performs a predetermined operation, the dispensing process of the JPY 100-yen coin begins, and 25 JPY 100-yen loose coins are dispensed from the loose coin outlet 370. The money dispensing processes are performed in the order of denominations, and loose coins are dispensed one denomination at a time.

In FIG. 8, an example in which the number of coin rolls to be replenished and the number of loose coins to be replenished are determined such that the number of coins being stored after the replenishment is the same as the number of fund reserve coins. However, the determination method can be changed by performing settings. For example, in one setting, only the coin rolls are dispensed such that the number of coins being stored after the replenishment does not exceed the number of fund reserve coins. In such a setting, the number of coins shown as the number of loose coins to be replenished in FIG. 8 is displayed as the number of surplus/lacking coins after replenishment. The number of surplus/lacking coins after replenishment is information that indicates how many coins are in surplus or lacking with respect to the number of fund reserve coins after the coin roll is corresponding to the number of coin rolls to be replenished are replenished into the cash settlement apparatus. Only the coin rolls are dispensed such that the number of coins being stored after the replenishment does not exceed the number of fund reserve coins, and therefore the number of surplus/lacking coins after replenishment becomes the same as the number of lacking coins after the replenishment with respect to the number of fund reserve coins.

In the setting in which only coin rolls are dispensed such that the number of coins being stored after the replenishment does not exceed the number of fund reserve coins, the money management apparatus 40 determines that the number of JPY 500-yen coin rolls to be replenished is zero. In this setting, the loose coins are not dispensed, and therefore a state in which 22 JPY 500-yen coins are in lacking continues even after the replenishment. On the screen, for the JPY 500-yen coin, the number of coin rolls to be replenished is displayed as “0”, and the number of surplus/lacking coins after replenishment is displayed as “−22”. For the JPY 100-yen coin, the determination is performed in the same way, and on the screen, the number of coin rolls to be replenished is displayed as “1”, and the number of surplus/lacking coins after replenishment is displayed as “−25”. For the coins of other denominations, the determination is performed in the same way, and the number of coin rolls to be replenished and the number of surplus/lacking coins after replenishment are displayed for each denomination on the screen. Then, when the cashier touches the dispensing start button on the screen, the loose coins are not dispensed, and the coin rolls of various denominations as shown under respective number of coin rolls to be replenished in FIG. 8 are dispensed.

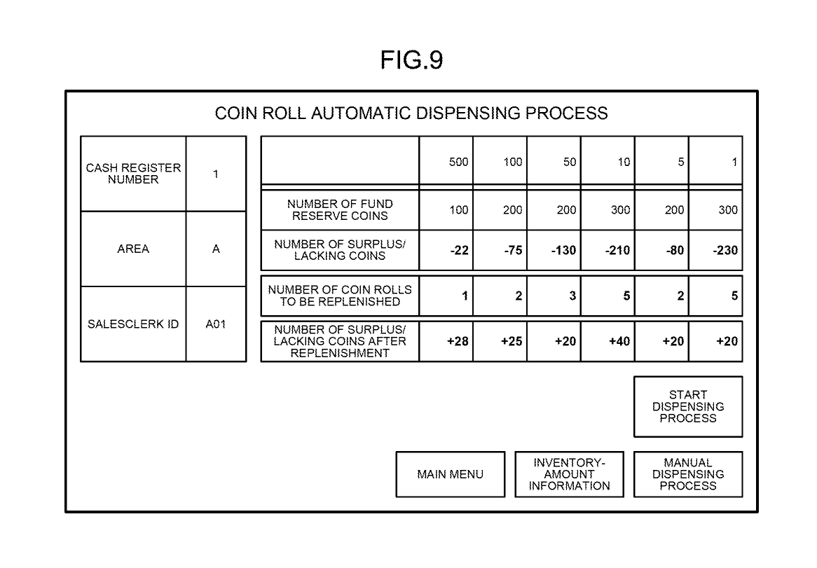

For example, in another setting, exceeding of the number of fund reserve coins is allowed, and all the coins for replenishing are dispensed in the form of the coin rolls to solve the coin shortage. FIG. 9 is a view of an exemplary screen that is displayed when the automatic dispensing process, in which exceeding of the number of change fund coins is allowed and only the coin rolls are dispensed, is executed. In such a setting, only the coin rolls are dispensed. Therefore, on the screen, instead of the number of loose coins to be replenished shown in FIG. 8, the number of surplus/lacking coins after replenishment is displayed. Exceeding of the number of fund reserve coins is allowed and all the coins for replenishment are dispensed in the form of the coin rolls, and therefore the number of surplus/lacking coins after replenishment becomes the same as the number of surplus coins after the replenishment with respect to the number of fund reserve coins.

In the setting in which exceeding of the number of fund reserve coins is allowed and only the coin rolls are dispensed, for example, to address the shortage of 22 JPY 500-yen coins with respect to 100 fund reserve coins, the money management apparatus 40 determines the number of coin rolls to be replenished as 1. With respect to the lacking 22 coins, 50 coins are replenished. Thus, after the replenishment, the number of coins in surplus by exceeding the number of fund reserve coins becomes 28. In other words, there are 28 surplus coins with respect to the number of fund reserve coins. Accordingly, as shown in FIG. 9, for the JPY 500-yen coin, the number of coin rolls to be replenished is displayed as “1”, and the number of surplus/lacking coins after replenishment is displayed as “+28”. For the JPY 100-yen coin, the determination is performed in the same way, and on the screen, the number of coin rolls to be replenished is displayed as “2”, and the number of surplus/lacking coins after replenishment is displayed as “+25”. For the coins of other denominations, the determination is performed in the same way, and the number of coin rolls to be replenished and the number of surplus/lacking coins after replenishment are displayed for each denomination on the screen. Then, when the dispensing start button on the screen is touched, the loose coins are not dispensed, and the coin rolls of various denominations as shown under the number of coin rolls to be replenished in FIG. 9 are dispensed. In this setting, the number of coin rolls to be replenished is derived by adding one spare coin roll to the number of coin rolls to be replenished shown in FIG. 8, and the coin rolls are dispensed.

On the screen shown in FIGS. 8 and 9, when the main menu button is touched instead of the dispensing start button, the coin dispensing process is not performed, and the screen returns to the main menu screen. Similarly, when an inventory-amount information button is touched instead of the dispensing start button, the coin dispensing process is not performed, and the screen returns to a screen that displays the coin inventory-amount information shown in FIG. 7. The cashier may want to chance the breakdown of the coin rolls and the loose coins for replenishment that is automatically determined by the money management apparatus 40 upon confirming the information displayed on the screen shown in FIGS. 8 and 9. In such a scenario, the cashier touches the manual dispensing button on the screen to execute the manual dispensing process explained below.

Even when execution of the manual dispensing process is selected by touching the manual dispensing button on the screen displaying the coin inventory-amount information as shown in FIG. 7, similar to the automatic dispensing process, a screen that prompts the cashier to input the cash register number, the area, and the salesclerk ID is displayed on the screen. When the cashier operates the operation/display unit 42 and inputs such information, a processing screen of the manual dispensing process is displayed. The settings on the information for which the input is prompted can be changed as long as the cash settlement apparatus can be identified based on that information. For example, the settings can be changed such that input of only the cash register number or the salesclerk ID is prompted.

When the cashier with the salesclerk ID “A01”, who is in charge of the POS register 11 of the cash register number “1” installed at the checkout counter in the area “A”, touches the manual dispensing button on the screen shown in any one of FIGS. 7, 8, and 9, the processing screen for the manual dispensing process is displayed on the screen of the operation/display unit 42.

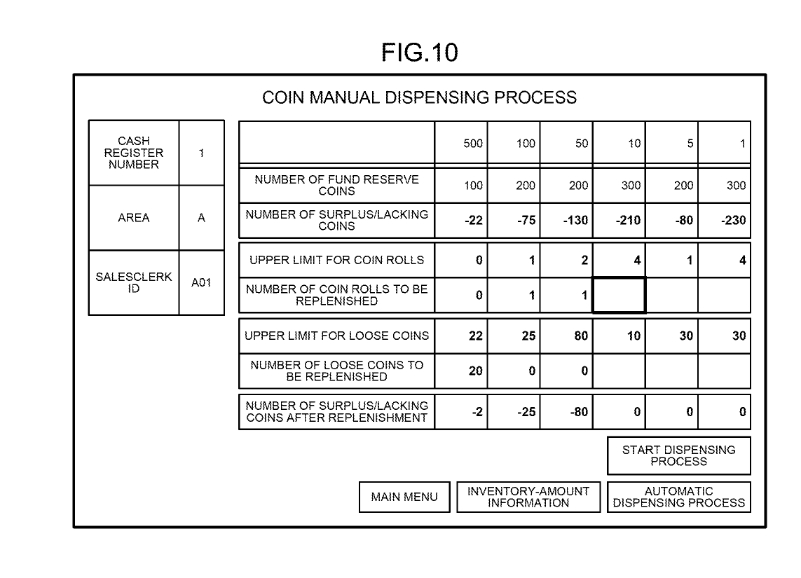

FIG. 10 is a view of an exemplary screen displayed when the manual dispensing process is executed. On the manual dispensing process screen, as the cash register information, the cash register number, the area, and the salesclerk ID are displayed. As the inventory-amount information, the number of fund reserve coins that indicates the number of coins of various denominations set as the change fund to be stored in the change dispenser 20 and the number of surplus/lacking coins that indicates the number of coins that is in surplus or lacking with respect to the number of fund reserve coins are displayed.

On the screen, below the number of surplus/lacking coins, an upper limit for coin rolls and the number of coin rolls to be replenished are displayed. The upper limit for coin rolls is a maximum number of coin rolls that can be replenished into the change dispenser 20 and the number of coins included in the coin rolls of the maximum number does not exceed the number of the lacking coins. The upper limit for coin rolls is automatically determined by the money management apparatus 40. The number of coin rolls to be replenished is the number of coin roll is to be replenished into the change dispenser 20. The number of coin rolls to be replenished is manually input by the cashier.

On the screen, below the number of coin rolls to be replenished, an upper limit for loose coins and the number of loose coins to be replenished are displayed. The upper limit for loose coins is the number of loose coins determined automatically by the money management apparatus 40 such that the number of coins combined with the number of coins in the coin rolls becomes the same as the number of coins in lacking. When the number of coin rolls to be replenished is not manually input, the money management apparatus 40 determines the upper limit for loose coins based on the upper limit for coin roll. When the number of coin rolls to be replenished is manually input, the display of the upper limit for loose coins gets updated based on the manually input number of coin rolls. The number of loose coins to be replenished is the number of loose coins to be replenished into the change dispenser 20. The number of loose coins to be replenished is manually input by the cashier.

On the screen, below the number of loose coins to be replenished, the number of surplus/lacking coins after replenishment is displayed. The number of surplus/lacking coins after replenishment is information on the state of the surplus/lacking in the number of coins with respect to the number of fund reserve coins after the coin rolls and the loose coins are replenished into the change dispenser 20. In a state in which the number of coin rolls to be replenished and the number of loose coins to be replenished are not manually input, the number of surplus/lacking coins after replenishment is determined based on the upper limit for coin rolls and the upper limit for loose coins. Therefore, the number of surplus/lacking coins after replenishment becomes zero. When the number of coin rolls to be replenished is manually input, the display of the number of surplus/lacking coins after replenishment gets updated based on the input number of coin rolls. Similarly, when the number of loose coins to be replenished is manually input, the display of the number of surplus/lacking coins after replenishment gets updated based on the input number of coins.

For example, for the JPY 500-yen coin, there are 22 coins in lacking with respect to the 100 fund reserve coins. The money management apparatus 40 determines, similar to when performing the automatic dispensing process shown in FIG. 8, the maximum number of coin rolls such that the number of lacking coins with respect to the change fund are dispensed in the form of as many coin rolls as possible. The determined number of the coin rolls is used as the upper limit for coin rolls. In other words, the money management apparatus 40 reduces the number of lacking coins with respect to the number of fund reserve coins by using the coin rolls on priority, and determines, as the number of coin rolls to be replenished, the number of coin rolls for replenishment such that the number of coins being stored after the replenishment does not exceed the number of fund reserve coins. The money management apparatus 40 determines the number of loose coins such that the number of coins combined with the number of coins to be dispensed in the form of coin rolls becomes the same as the number of lacking coins. The determined number of loose coins is used as the upper limit for loose coins. As a result, as shown in FIG. 10, the upper limit for coin rolls of JPY 500-yen coin is determined as zero, and the upper limit for loose coins is determined as 22. Similarly, for the JPY 100-yen coin, the upper limit for coin rolls is determined as 1, and the upper limit for loose coins is determined as 25. Similarly, for coins of other denominations, the upper limit for coin rolls and the upper limit for loose coins are determined so as to be the same as the number of lacking coins in a combination of as many coin rolls as possible and as few loose coins as possible.

The cashier operates the operation/display unit 42 while referring to the upper limit for coin rolls and the upper limit for loose coins displayed on the screen. The cashier manually inputs, in the number of coin rolls to be replenished field provided on the screen, the number of coin rolls of various denominations that the cashier wants to replenish the change dispenser 20. The cashier manually inputs, in the number of loose coins to be replenished field provided on the screen, the number of loose coins of various denominations that the cashier wants to replenish the change dispenser 20. When the number of coin rolls that is different from the upper limit for coin rolls is input as the number of coin rolls to be replenished, the money management apparatus 40 updates the displayed value of the upper limit for loose coins based on the input number of coin rolls. When the number of loose coins that is different from the upper limit for loose coins is input as the number of loose coins to be replenished, the money management apparatus 40 updates the displayed value of the number of surplus/lacking coins after replenishment based on the input number of loose coins.

FIG. 10 shows a state in which the field of the number of coin rolls to be replenished for the JPY 10-yen coin is selected to input the number of JPY 10-yen coin rolls to be replenished into the change dispenser 20. As it can be understood from the information displayed in the columns of the JPY 10-yen coin, JPY 5-yen coin, and JPY 1-yen coin, before the information on the coin rolls and the loose coins to be replenished is input, the fields of the number of coin rolls to be replenished and the number of loose coins to be replenished provided on the screen are blank.

For example, for the JPY 500-yen coin, 22 coins are in lacking with respect to 100 fund reserve coins. After the manual dispensing process has begun, the upper limit for coin rolls displayed as “0”, the upper limit for loose coins is displayed as “22”, and the number of surplus/lacking coins after replenishment is displayed as “0”. The cashier operates the operation/display unit 42 to input “0” in the number of coin rolls to be replenished field and “20” in the number of loose coins to be replenished field. Such input indicates that 20 loose coins will be replenished with respect to 22 coins in lacking. As a result, even after the replenishment, there are two coins in lacking with respect to the number of fund reserve coins. Therefore, the display of the number of surplus/lacking coins after replenishment for the JPY 500-yen coin gets updated from “0” to “−2”.

For the JPY 100-yen coin, 75 coins are in lacking with respect to 200 fund reserve coins. After the manual dispensing process has begun, the upper limit for coin rolls is displayed as “1”, and the upper limit for loose coins is displayed as “25”. When the number of coin rolls to be replenished and the number of loose coins to be replenished for the JPY 100-yen coin are not input, the number of surplus/lacking coins after replenishment is displayed as “0”. The cashier operates the operation/display unit 42 to input “1” in the number of coin rolls to be replenished field and “0” in the number of loose coins to be replenished field. Such input indicates that 50 coins will be replenished with respect to 75 coins in lacking. As a result, even after the replenishment, there are 25 loose coins in lacking with respect to the number of fund reserve coins. Therefore, the display of the number of surplus/lacking coins after replenishment for the JPY 100-yen coin gets updated from “0” to “−25”.

For the JPY 50-yen coin, 130 coins are in lacking with respect to 200 fund reserve coins. After the manual dispensing process has begun, the upper limit for coin rolls is displayed as “2”, the upper limit for loose coins is displayed as “30”, and the number of surplus/lacking coins after replenishment is displayed as “0”. In this state, when the cashier operates the operation/display unit 42 to input “1” in the number of coin rolls to be replenished field, the money management apparatus 40 updates the upper limit for loose coins based on the input number of coin rolls to be replenished. Specifically, the money management apparatus 40 updates the upper limit for loose coins that is displayed as “30” that is displayed corresponding to the upper limit of two coin rolls (=130 coins−50 coins×2 coin rolls) to 80 corresponding to the manually input value of “1” coin roll to be replenished (=130 coins−50 coins×1 coin roll). Subsequently, the cashier inputs “0” in the number of loose coins to be replenished field. Such input indicates that 50 coins included in one coin roll are replenished with respect to the 130 coins in lacking. As a result, even after the replenishment, there are 80 coins in lacking with respect to the number of fund reserve coins. Therefore, the display of the number of surplus/lacking coins after replenishment for the JPY 50 coin gets updated from “0” to “−80”.

For the JPY 10-yen coin, 210 coins are in lacking with respect to 300 fund reserve coins. After the manual dispensing process has begun, the upper limit for coin rolls is displayed as “4”, the upper limit for loose coins is displayed as “10”, and the number of surplus/lacking coins after replenishment is displayed as “0”. In this state, when the cashier operates the operation/display unit 42 to input “4” in the number of coin rolls to be replenished field, the displayed value of the upper limit for loose coins remains as is to “10”. In contrast to this, for example, when the cashier inputs “2” in the number of coin rolls to be replenished field, the upper limit for loose coins is recalculated such that the total number of coins derived by summing the value of the upper limit for loose coins to the number of coins included in the two coin rolls, that is, 100, is equivalent to the 210 lacking coins. As a result, the display of the upper limit for loose coins gets updated from “10” to “110”.

When performing the manual dispensing process in the money management apparatus 40, the cashier can input a desired value as the number of coin rolls to be replenished and the number of loose coins to be replenished. However, the range of values that can be input as the number of coin rolls to be replenished and the number of loose coins to be replenished can be restricted to a predetermined range of values.

For example, the upper limit for coins of each denomination can be set such that the number of coins being stored in the change dispenser 20 after the replenishment does not exceed the full number of coins indicating maximum number of coins that can be stored in the change dispenser 20. In this setting, desired values can be input as the number of coin rolls to be replenished and the number of loose coins to be replenished as long as the number of coins being stored in the change dispenser 20 after the replenishment, in which the change dispenser 20 is replenished with the coin rolls equivalent to the input number of coin rolls to be replenished and the loose coins equivalent to the input number of loose coins to be replenished, does not exceed the full number of coins.

For another example, the upper limit for each denomination can be set such that the number of coins being stored in the change dispenser 20 after the replenishment does not exceed the number of fund reserve coins. Specifically, for example, the upper limit for JPY 10-yen coins shown in FIG. 10 is set to 300, which is the same as the number of fund reserve coins. In such a case, the number of JPY 10-yen coins that can be replenished is 210, which is the same as the number of lacking coins. Therefore, the cashier can input a desired value as the number of coin rolls to be replenished that is within the range of 0 to 4 such that the number of loose coins included in the coin rolls to be replenished does not exceed 210. In other words, in the example shown in FIG. 10, the cashier can input a desired value as the number of coin rolls to be replenished as long as that value does not exceed the upper limit 4 that is automatically determined by the money management apparatus 40. The cashier can input a desired value as the number of loose coins to be replenished as long as the total number of coins in combination with the number of loose coins included in the coin rolls of the number of coin rolls to be replenished input earlier does not exceed 210 coins. For example, when “0” is input as the number of coin rolls to be replenished, the cashier can input a desired value within the range of 0 to 210 as the number of loose coins to be replenished. When “1” is input as the number of coin rolls to be replenished, the cashier can input a desired value within the range of 0 to 160 as the number of loose coins to be replenished. When “4”, which is the upper limit for coin rolls, is input as the number of coin rolls to be replenished, the cashier can input a desired value within the range of 0 to 10 as the number of loose coins to be replenished.

For another example, an upper limit derived by adding 50 loose coins included in one coin roll to the number of the fund reserve coins can be set. Specifically, for example, the upper limit for JPY 10-yen coins shown in FIG. 10 can be set to 350 that is derived by adding 50 coins included in one coin roll to the 300 fund reserve coins. In such a case, the number of JPY 10-yen coins that can be replenished becomes 260 that is a value derived by adding 50 coins to the 210 lacking coins. Therefore, the cashier can input a desired value as the number of coin rolls to be replenished that is within the range of 0 to 5 in which the number of coins in the coin rolls to be replenished does not exceed 260 coins. In other words, in the example shown in FIG. 10, the cashier can input a desired value as the number of coin rolls to be replenished that exceeds the upper limit of 4 that is automatically determined by the money management apparatus 40. Specifically, the cashier can input a desired value as the number of coin rolls to be replenished that is within the range of 0 to 5 that is derived by adding one spare coin roll to the upper limit of four coin rolls. The cashier can input a desired value as the number of loose coins to be replenished as long as the total number of coins in combination with the number of coins in the coin rolls of the number of coin rolls to be replenished input earlier does not exceed 260. For example, when “0” is input as the number of coin rolls to be replenished, the cashier can input a desired value within the range of 0 to 260 as the number of loose coins to be replenished. When “1” is input as the number of coin rolls to be replenished, the cashier can input a desired value within the range of 0 to 210 as the number of loose coins to be replenished. When “4” is input as the number of coin rolls to be replenished, which is the upper limit for coin rolls, the cashier can input a desired value within the range of 0 to 60 as the number of loose coins to be replenished. When “5” is input as the number of coin rolls to be replenished, which is derived by adding one spare coin roll to the upper limit for coin rolls and exceeds the upper limit for coin rolls, the cashier can input a desired value within the range of 0 to 10 as the number of loose coins to be replenished.

For another example, by setting the upper limit the same as the number of fund reserve coins, only the number of coin rolls to be replenished can be set such that the upper limit for coin rolls is allowed to be exceeded only by one coin roll. Specifically, for example, concerning the four coin rolls of JPY 10-yen coin indicated as the upper limit for coin rolls in FIG. 10, it is allowed to input a desired value between 0 and 5, which is derived by adding one spare roll to the upper limit of four coin rolls, as the number of coin rolls to be replenished. In such a setting, when “0” is input as the number of coin rolls to be replenished, the cashier can input a desired value within the range of 0 to 210 as the number of loose coins to be replenished. When “1” is input as the number of coin rolls to be replenished, the cashier can input a desired value within the range of 0 to 160 as the number of loose coins to be replenished. When “4” is input as the number of coin rolls to be replenished, which is the upper limit for coin rolls, the cashier can input a desired value within the range of 0 to 10 as the number of loose coins to be replenished. When the cashier inputs “5” as the number of coin rolls to be replenished, which is derived by adding one spare coin roll to the upper limit for coin rolls and exceeds the upper limit for coin rolls, the number of loose coins included in the coin rolls to be replenished becomes 250 coins that exceed 210 coins in lacking. Therefore, the cashier can only input “0” as the number of loose coins to be replenished. In such a case, the number of surplus/lacking coins is displayed as “+40”.

In a state in which the range of the values that can be input in the money management apparatus 40 as the number of coin rolls to be replenished and the number of loose coins to be replenished is restricted, if a value that exceeds the setting range is input, the money management apparatus 40 performs a predetermined processing. For example, when a value that exceeds the setting range is input, a warning is issued to the cashier, and the money management apparatus 40 displays on the screen the setting range and information that instructs the cashier to input a value within the setting range. For another example, the money management apparatus 40 automatically changes the input value that exceeds the setting range to the value of the upper limit of the setting range, and displays on the screen information notifying the cashier that the input value has been changed to the upper limit of the setting range.

The money management apparatus 40 can receive the selection of the money change process on the main menu screen and perform the money change. For example, during the business hours of the store, when a shortage of change money occurs in the cash register, the cashier takes the money out of the change dispenser 20 or the drawer 30 of the checkout counter that the cashier is in charge of, and goes to the back office. The cashier then inputs in the money management apparatus 40 information such as the cash register number, the area, and the salesclerk ID, and performs the money change process to change the brought-in money. Once the money change process is completed, the cashier returns to the checkout counter and stores the changed money in the change dispenser 20 or the drawer 30 of the checkout counter.

To change the large-denomination banknotes into the small-denomination banknotes, the cashier deposits loose banknotes of the large denomination in the loose banknote handling unit 100 of the money management apparatus 40, and specifies the denomination of the loose banknotes to be received after the money change process. Upon receiving the operation in which the denomination is specified, the money management apparatus 40 dispenses the amount of the deposited loose banknotes of the large denomination in the form of a plurality of the loose banknotes of the specified small denomination. For the denomination of the loose banknotes to be received after the money change process, one denomination can be specified, or a plurality of the denominations can be specified.

To change banknotes into coins, the cashier deposits the loose banknotes in the loose banknote handling unit 100, and specifies the denomination of the coins to be received after the money change process. To change coins into coins, the cashier deposits the loose coins in the loose coin handling unit 300, and specifies the denomination of the coins to be received after the money change process.

At the time of changing into the coins, the money management apparatus 40 can dispense the coins to be received after the money change process in the form of only the loose coins, only the coin rolls, or in the combination of the loose coins and the coin rolls. For the denomination of the coins to be received after the money change process, the cashier can specify one denomination, or a plurality of the denominations.

For example, the money change process for changing JPY 10,000-yen loose banknote into coins, and the money change process for changing 20 JPY 500-yen coins into other coins are performed in the same way. The cashier deposits the JPY 10,000-yen loose banknote or the loose coins worth JPY 10,000-yen, and specifies JPY 50-yen as the denomination of the coins to be received after the money change process. Upon receiving the specification, the money management apparatus 40 displays on the screen of the operation/display unit 42 information indicating that four JPY 50-yen coin rolls are dispensed. The cashier can select on the screen to have the entire amount of money changed and dispensed in the form of four coin rolls, or in the form of 200 loose coins. Moreover, the cashier can select to have the changed money in the form of coin rolls and loose coins by manually inputting the number of coin rolls or the number of loose coins to specify the breakdown of the loose coins and the coin rolls to be dispensed. For example, the cashier can have the changed money in the form of three coin rolls and 50 loose coins. According to the details of the selection, the coin rolls to be received after the money change process are dispensed from the coin roll handling unit 400, and the loose coins are dispensed from the loose coin handling unit 300.

For example, after depositing JPY 10,000-yen in the form of the loose banknotes or loose coins, the cashier specifies two denominations of JPY 50-yen coin and JPY 10-yen coin as the denominations to be received after the money change process. Upon receiving the specification, the money management apparatus 40 displays on the screen of the operation/display unit 42 information indicating that half of the deposited amount is changed into JPY 50-yen coins and the remaining half is changed into JPY 10-yen coins, and two JPY 50-yen coin rolls and 10 JPY 10-yen coin rolls are dispensed. Concerning the coins of each denomination, the cashier can select either to change the deposited money into only the coin rolls, only the loose coins, or in the combination of the coin rolls and the loose coins. To change the deposited money into the coin rolls and the loose coins, the cashier can input the number of coin rolls or the number of coins for the loose coins to specify the breakdown of the coin rolls and the loose coins, for each denomination. The cashier can change the ratio of the various denominations in the changed amount such that, for example, the amount of JPY 7,500-yen is changed into JPY 50-yen coins, and the amount of JPY 2,500-yen is changed into JPY 10-yen coins.

Concerning setting of the number of pieces of money for each denominations in a case where a plurality of denominations is specified to receive after the money change process, according to the amount to be changed and the specified denominations, the combination of the denominations and the numbers of pieces of the money to be dispensed can be set beforehand.

At the time of performing the money change process, instead of processing all the money via the money change process, the money management apparatus 40 can process a part of the money deposited for the money change process via the money depositing process performed for depositing into the money management apparatus 40 as the money collected from the checkout counter. The money management apparatus 40 can dispense a part of the money deposited for the money change process. For example, after depositing one JPY 10,000-yen banknote for the money change process, the cashier can specify the amount to be changed such that JPY 5,000-yen are changed and the remaining JPY 5,000-yen are deposited in the money management apparatus 40 via the money depositing process as the money collected from the checkout counter. Similarly, for example, without confirming the details of the denominations or the amount, a plurality of the loose coins taken from the drawer 30 are deposited in the loose coin handling unit 300, and as a result, the total amount is JPY 5,400-yen. The cashier can process the money for JPY 5,000-yen via the money change process, and deposit the money for JPY 400-yen in the money management apparatus 40 via the money depositing process as the money collected from the checkout counter. For another example, among JPY 5,400-yen deposited in the loose coin handling unit 300, the cashier can also specify to process the amount of JPY 5,000-yen via the money change process and have the amount of JPY 400-yen returned such that the coins worth JPY 400-yen are returned from the loose coin outlet 370. In such a case, the cashier returns the returned loose coins and the loose coins received after the money change process into the cash settlement apparatus of the checkout counter. After the cashier specifies the amount to be changed, the money change process is performed as explained above.

In the present embodiment, a configuration of the money management apparatus 40 that includes the loose banknote handling unit 100, the banknote bundle handling unit 200, the loose coin handling unit 300, and the coin roll handling unit 400 is explained. However, the money management apparatus 40 can perform only the money management processing, and a money handling apparatus is provided separately from the money management apparatus 40, and is constituted by the loose banknote handling unit 100, the banknote bundle handling unit 200, the loose coin handling unit 300, and the coin roll handling unit 400.

In the present embodiment, an example in which, at the time of performing the money dispensing process and the money change process in the money management apparatus 40, the setting in which the coin rolls are prioritized over the loose coins and as many coins as possible are dispensed in the form of the coin rolls is given. However, prioritizing the dispensing of the coin rolls or the loose coins can be changed by performing appropriate setting operations. When it is set to prioritize the loose coins, it is automatically determined that the entire amount is to be dispensed in the form of loose coins. In such a scenario, as explained above, the cashier can manually change the breakdown of the coin rolls and the loose coins. The priority can be set for each cash settlement apparatus. For example, a setting can be performed such that, based on the cash register number and the like input at the time of dispensing money, the money management apparatus 40 determines the type of the cash settlement apparatus, prioritizes the loose coins in the money dispensing process for replenishing the change dispenser 20 with coins, and prioritizes the coin rolls in the money dispensing process for replenishing the drawer 30 with coins. With such configuration, when dispensing the coins to be replenished in the drawer 30 that can store the coin rolls as is, the coin rolls can be dispensed on priority. When dispensing the coins to be replenished into the change dispenser 20, the coin rolls are needed to be unwrapped and stored therein as loose coins, and therefore the loose coins can be dispensed on priority. For example, a setting can be performed such that, based on the area information and the like input at the time of performing money dispensing process, the money management apparatus 40 determines the area in which the cash settlement apparatus is installed, and when the back office in which the money management apparatus 40 is installed is away from the checkout counter at which the cash settlement apparatus installed, prioritizes the coin rolls such that carrying coins becomes easier, and when the back office in which the money management apparatus 40 is installed is near the checkout counter at which the cash settlement apparatus is installed, the loose coins are prioritized. According to the usage or storing form of the coins in the cash settlement apparatus, distance needed to travel to bring the coins dispensed by the money management apparatus 40 to the cash settlement apparatus, and the like, the priority of the coin rolls or the loose coins can be set. With such configuration, at the time of performing the money dispensing process and the money change process in the money management apparatus 40, the priority-based process can be performed, and burden of carrying out processing on the cashier can be lessened.

As explained above, in the money management apparatus 40 according to the present embodiment, at the time of dispensing coins for receiving a change or for money changing, a setting can be performed to instruct whether to prioritize the loose coins or the coin rolls. The user, for example, can perform settings such that the coins are dispensed in the form of the coin rolls as much as possible. The money management apparatus 40 can receive via the screen, on which information on the coins to be dispensed can be confirmed, the instructions from the user to change a part of or all the coins to be dispensed in the form of the loose coins. For example, the user can perform settings to dispense all the coins in the form of the loose coins. Alternatively, the money management apparatus 40 can receive via the screen, on which information on the coins to be dispensed can be confirmed, the instructions from the user to change a part of or all the coins to be dispensed in the form of the coin rolls. The money management apparatus 40 can dispense the required quantity of the coins in a form that is easy to use in the store based on the settings allowed in the store.

### INDUSTRIAL APPLICABILITY

As explained above, the money management apparatus, the money handling system, and the money handling method according to the present invention are useful in dispensing the loose money or wrapped money based on the requirement.

### EXPLANATION OF REFERENCE NUMERALS

11, 12 POS register
20 change dispenser
21 loose banknote handling unit
22 loose coin handling unit
30 drawer
40 money management apparatus
41 control unit
42 operation/display unit
43 memory
44 communication unit
50 network
100 loose banknote handling unit
200 banknote bundle handling unit
300 loose coin handling unit
400 coin roll handling unit

1. A money handling system comprising:
at least one cash settlement apparatus configured to store therein money for being utilized as change; and
a money management apparatus that includes
a communication unit configured to acquire information on money for replenishing the cash settlement apparatus;
a loose money handling unit configured to dispense loose money for replenishing the cash settlement apparatus; and
a wrapped money handling unit configured to dispense wrapped money for replenishing the cash settlement apparatus.

2. The money handling system as claimed in claim 1, wherein
the wrapped money that the wrapped money handling unit dispenses includes a coin roll in which a predetermined number of coins are wrapped.

3. The money handling system as claimed in claim 1, wherein
the wrapped money that the wrapped money handling unit dispenses includes a banknote bundle in which a predetermined number of banknotes are bundled.

4. The money handling system as claimed in claim 1, wherein
the loose money handling unit receives the loose money and stores the loose money inside the apparatus, and utilizes the stored loose money for replenishing the cash settlement apparatus.

5. The money handling system as claimed in claim 1, wherein
the money management apparatus determines, based on information on a money storage quantity of the cash settlement apparatus, a quantity of money to be dispensed for replenishing the cash settlement apparatus.

6. The money handling system as claimed in claim 5, wherein
the money management apparatus determines, based on information on a quantity of money set to be stored in the cash settlement apparatus and a quantity of money being stored in the cash settlement apparatus, the quantity of money to be dispensed for replenishing the cash settlement apparatus.

7. The money handling system as claimed in claim 5, wherein
the money management apparatus receives information input to identify the cash settlement apparatus, identifies the cash settlement apparatus to be replenished among a plurality of cash settlement apparatuses based on the received information, and determines the quantity of money to be dispensed for replenishing an identified cash settlement apparatus.

8. The money handling system as claimed in claim 5, wherein
the money management apparatus determines the quantity of money to be dispensed for replenishing the cash settlement apparatus such that a determined quantity of money does not exceed a shortfall quantity of money derived by subtracting the quantity of money being stored in the cash settlement apparatus from the quantity of money set to be stored in the cash settlement apparatus.

9. The money handling system as claimed in claim 5, wherein
the money management apparatus determines a breakdown of the loose money to be dispensed from the loose money handling unit and the wrapped money to be dispensed from the wrapped money handling unit such that a total quantity of the loose money and the wrapped money is the same as the determined quantity of money to be dispensed for replenishing the cash settlement apparatus.

10. The money handling system as claimed in claim 5, wherein
the money management apparatus determines a maximum quantity of wrapped money such that the quantity of money included in the maximum quantity of wrapped money does not exceed the determined quantity of money to be dispensed for replenishing the cash settlement apparatus, and dispenses the determined maximum quantity of wrapped money.

11. The money handling system as claimed in claim 10, wherein
when the quantity of money included in the determined maximum quantity of wrapped money is less than the determined quantity of money to be dispensed for replenishing the cash settlement apparatus, the money management apparatus dispenses a shortfall quantity of money in a form of loose money.

12. The money handling system as claimed in claim 10, wherein
when the quantity of money included in the determined maximum quantity of wrapped money is less than the determined quantity of money to be dispensed for replenishing the cash settlement apparatus, the money management apparatus dispenses spare wrapped money.

13. The money handling system as claimed in claim 5, wherein
the money management apparatus has setting information set for each cash settlement apparatus, the setting information indicating whether the loose money or the wrapped money is prioritized, and determines, based on the setting information, whether the loose money or the wrapped money is prioritized to dispense the determined quantity of money for replenishing the cash settlement apparatus.

14. The money handling system as claimed in claim 5, wherein
the money management apparatus further includes an operation unit to specify a breakdown of the loose money and the wrapped money to be dispensed for replenishing the cash settlement apparatus.

15. The money handling system as claimed in claim 14, wherein
the money management apparatus compares the determined quantity of money to be dispensed for replenishing the cash settlement apparatus and a total quantity of money derived by summing a quantity of the loose money and a quantity of the wrapped money specified via the operation unit, and performs a predetermined processing.

16. A money management apparatus comprising:
a communication unit configured to acquire information on money to be replenished a cash settlement apparatus that stores therein money for being utilized as change;
a loose money handling unit configured to dispense loose money for replenishing the cash settlement apparatus; and
a wrapped money handling unit configured to dispense wrapped money for replenishing the cash settlement apparatus.

17. A money handling method for dispensing money for replenishing into a cash settlement apparatus in a money handling system, the money handling method comprising:
acquiring information on money to be replenished the cash settlement apparatus;
dispensing loose money for replenishing the cash settlement apparatus; and
dispensing wrapped money for replenishing the cash settlement apparatus.
